(19) United States
(12) Patent Application Publication
(10) Pub. No.: US 2009/0086090 A1
(43) Pub. Date: Apr. 2, 2009

(54) Picture signal processing apparatus and picture signal processing method

(75) Inventor: Masaki Uchida, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/284,798

(22) Filed: Sep. 25, 2008

(30) Foreign Application Priority Data
Oct. 1, 2007 (JP) P2007-257506

(51) Int. Cl. H04N 7/01

(52) U.S. Cl. 348/441; 348/E07.003

(57) ABSTRACT

A picture signal processing apparatus is disclosed, which performs a frame rate conversion for an input picture signal and obtains an output picture signal. The storing section stores picture data for two frames or more. The picture measuring section measures picture information of the input picture signal for which the frame rate conversion has not been performed using a frame delay period which occurs when the frame rate conversion is performed. The control information generating section generates control information based on the picture data to perform a high quality picture producing process based on the picture information and stores the generated control information and the picture data associated therewith to the storing section. The frame rate converting section performs the frame rate conversion for the picture data supplied from the storing section based on the control information supplied from the storing section.

### CROSS REFERENCES TO RELATED APPLICATIONS

The present invention contains subject matter related to Japanese Patent Application JP 2007-257506 filed in the Japanese Patent Office on Oct. 1, 2007, the entire contents of which being incorporated herein by reference.

### BACKGROUND OF THE INVENTION

1. Field of the Invention

The present invention relates to a picture signal processing apparatus and a picture signal processing method disposed, for example, in a television receiver.

2. Description of the Related Art

A high quality picture producing process is performed for a picture signal supplied to a display. The high quality picture producing process includes, for example, contour correcting process and contrast correcting process. Patent Document 1, Japanese Patent Application Laid-Open No. 2005-176060, describes an apparatus for the high quality picture producing process that generates a luminance signal based on an input RGB signal, detects a maximum luminance difference of the luminance signal, stores the detected maximum luminance difference, converts the maximum luminance difference into a contour correction amount, obtains the temporal average of the contour correction amount, forms a contour emphasis gain signal based on the temporal average, adjusts the gain based on the contour emphasis gain signal, generates a contour correction signal, and corrects a contour based on the contour correction signal. In addition, Patent Document 1 describes that a central processing unit (CPU) generates a correction signal.

In the apparatus for high quality picture producing process that performs, for example, contour correction as described in Patent Document 1, optimum high quality picture producing control is performed on the basis of measured picture information of a picture, for example, the foregoing maximum luminance difference of the luminance signal. It takes some time to generate picture control information, for example, contour correction signal, based on the measured picture signal. Thus, a picture from which the measured picture information has been obtained may deviate from a picture to be processed on the basis of the picture control signal by one frame. Since such deviation adversely affects control, a problem may arise.

A frame memory is used to prevent pictures from deviating. In other words, after a picture is measured, picture data are temporarily stored in the frame memory such that picture data is delayed for a period in which the CPU can calculate the picture control information.

### SUMMARY OF THE INVENTION

In such a phase matching method, the following problems may arise.
The delay of video frames of the entire system increases.
A communication band between the high quality picture producing circuit and the frame memory is wasted.
An area necessary for the frame memory increases.

In view of the foregoing, it would be desirable to provide a picture signal processing apparatus and a picture signal processing method that can solve the foregoing problems and accomplish optimum dynamic high quality picture producing control based on picture information.

According to an embodiment of the present invention, there is provided a picture signal processing apparatus which performs a frame rate conversion for an input picture signal and obtains an output picture signal. The picture signal processing apparatus includes a storing section, a picture measuring section, a control information generating section, a frame rate converting section, and a picture process controlling section. The storing section stores picture data for two frames or more. The picture measuring section measures picture information of the input picture signal for which the frame rate conversion has not been performed using a frame delay period which occurs when the frame rate conversion is performed. The control information generating section generates control information based on the picture data to perform a high quality picture producing process based on the picture information and stores the generated control information and the picture data associated therewith to the storing section. The frame rate converting section performs the frame rate conversion for the picture data supplied from the storing section based on the control information supplied from the storing section. The picture process controlling section performs the high quality picture producing process for the picture data supplied from the frame rate converting section based on the control information supplied from the frame rate converting section. The picture process controlling section matches phases of the picture data and high quality picture producing control.

According to an embodiment of the present invention, there is provided a picture signal processing method of performing a frame rate conversion for an input picture signal and obtaining an output picture signal. Picture information of the input picture signal for which the frame rate conversion has not been performed is measured using a frame delay period which occurs when the frame rate conversion is performed. Control information is generated based on the picture data to perform a high quality picture producing process based on the picture information and storing the generated control information and the picture data associated therewith to storing means. The frame rate conversion for the picture data supplied from the storing means is performed based on the control information supplied from the storing means. The high quality picture producing process for the picture data supplied is performed after the frame rate converting step based on the control information supplied after the frame rate converting step. The picture process controlling step is performed by matching phases of the picture data and high quality picture producing control.

According to embodiments of the present invention, phases of control information for a high quality picture producing process calculated by a CPU and an output picture signal can be matched based on measured picture signal without accessing a frame memory. As a result, high quality picture producing control can be optimally and dynamically performed. Thus, according to embodiments of the present invention, in high quality picture producing process, a CPU can perform processes only in synchronization with an input vertical synchronous signal. Thus, structure and processes for high quality picture producing control can be simplified.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a block diagram showing an exemplary structure of a picture signal processing apparatus according to an embodiment of the present invention;

FIG. 2 is a timing chart showing an exemplary process according to an embodiment of the present invention;

FIG. 3 is a timing chart showing an exemplary frame rate converting process according to an embodiment of the present invention;

FIG. 4 is a schematic diagram showing exemplary mapping of a frame memory according to an embodiment of the present invention; and

FIG. 5 is a timing chart showing a specifically exemplary process according to an embodiment of the present invention.

### DETAILED DESCRIPTION OF THE PREFERRED EMBODIMENTS

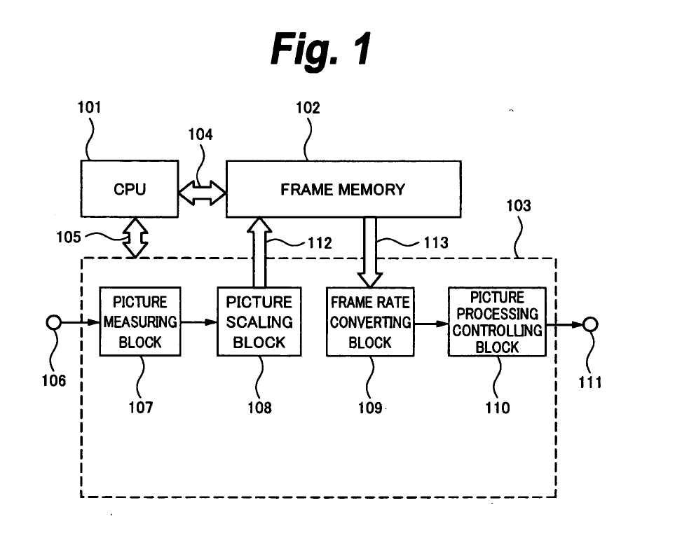

Next, with reference to the accompanying drawings, a picture signal processing apparatus according to an embodiment of the present invention will be described. As shown in FIG. 1, the picture signal processing apparatus according to this embodiment is composed of a CPU 101, a frame memory 102, and a picture signal processing block 103. Connected between the CPU 101 and the frame memory 102 is a memory bus 104. Connected between the CPU 101 and the picture signal processing block 103 is a register bus 105.

The picture signal processing block 103 has a picture measuring block 107 connected to a picture signal (eg, digital luminance signal) input terminal 106; a picture scaling block 108 connected to the picture measuring block 107; a frame rate converting block 109; and a picture processing controlling block 110 for a high quality picture producing process. The picture processing controlling block 110 supplies an output picture signal for which the frame rate conversion and high quality picture producing process have been performed to an output terminal 111.

Disposed between the picture scaling block 108 and the frame memory 102 is a memory bus 112. Disposed between the frame memory 102 and the frame rate converting block 109 is a memory bus 113.

The picture measuring block 107 measures desired information of the input picture signal corresponding to the high quality picture producing process to generate a control signal necessary for the high quality picture producing process based on the input picture signal. The high quality picture producing process includes contour correction. The picture measuring block 107 measures, for example, average picture luminance (APL) of a picture for one frame to be processed. The picture processing controlling block 110 controls luminance input/output characteristics corresponding to APL. The picture measuring block 107 may measure a luminance histogram for one frame instead of APL. Details of exemplary dynamic picture quality control will be described later.

The CPU 101 reads measured information of the picture measuring block 107 through the register bus 105. The CPU 101 calculates control information to be set to the picture processing controlling block 110 and supplies control information (eg, register value) that the CPU 101 has calculated to the frame memory 102 through the memory bus 104.

The picture scaling block 108 enlarges or reduces the input picture signal corresponding, for example, to resolution and so forth of the display panel. When the display panel displays, for example, (1920×1080) progressive signal and the input picture signal is (720×480) interlace (interlaced scanning) signal, the picture scaling block 108 performs an enlarging process for the input picture signal and generates a picture signal having a size of the display panel.

Picture data that have been processed in the picture scaling block 108 are written to the frame memory 102 through the memory bus 112. Thereafter, the control information calculated by the CPU 101 is packed with the picture data and then the packed data are stored in the frame memory 102. Packing represents a process of associating picture data, for example, for one frame with corresponding control signal and storing the associated data in the frame memory 102. In other words, picture data and control data associated therewith can be read together from the frame memory 102. For example, a table that associates picture data with control information may be created and picture data and control information may be read from the table by reference.

Picture data and control information are read from the frame memory 102. The picture data and control information that have been read from the frame memory 102 are supplied to the frame rate converting block 109 through the memory bus 113. The frame rate converting block 109 performs the frame rate conversion for the picture data.

The picture signal for which the frame rate conversion has been performed by the frame rate converting block 109 is supplied to the picture processing controlling block 110. The picture processing controlling block 110 performs the high quality picture producing process for the picture signal. The control information for the high quality picture producing process is read from the frame memory 102 in a blanking period before the picture signal is read therefrom. The picture processing controlling block 110 for the high quality picture producing process updates high quality picture producing setting in a vertical blanking interval. The picture processing controlling block 110 performs the high quality picture producing process for the picture signal and supplies the picture signal of the produced high quality picture for which the appropriate frame rate conversion has been performed to the output terminal 111.

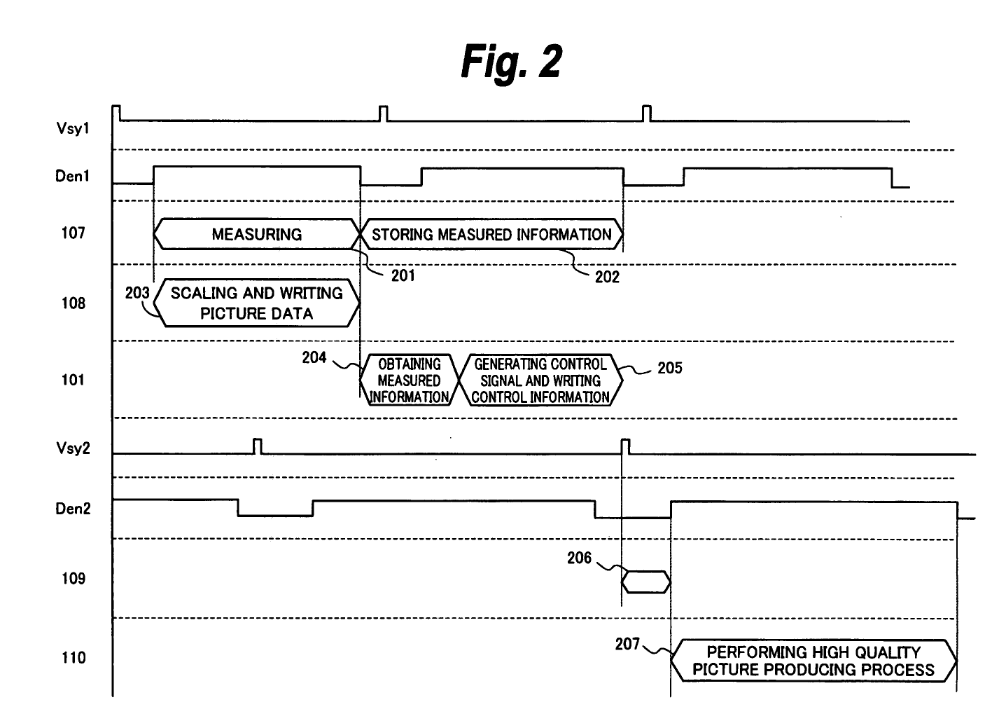

Next, with reference to a timing chart shown in FIG. 2, a process according to an embodiment of the present invention will be described in time series. In FIG. 2, Vsy1 represents a vertical synchronous signal in synchronization with the input picture signal; Den1 represents a data enable signal in synchronization with the input picture signal. A high level period of the data enable signal Den1 is a period for which picture data exist whereas a low level period thereof is a vertical blanking interval. The timing chart shown in FIG. 2 is focused on a process for a part of one vertical region.

The picture measuring block 107 measures APL and so forth of a picture in a picture data region of one vertical region of the input picture signal (region 201). The picture measuring block 107 stores the measured result in the next one vertical region (region 202). The picture scaling block 108 scales the picture signal in one vertical region to be measured by the picture measuring block 107 and writes the scaled picture data to the frame memory 102 through the memory bus 112 (region 203).

The CPU 101 performs a process in synchronization with the vertical synchronous signal Vsy1 of the input picture data. The CPU 101 obtains the measured information from the picture measuring block 107 (region 204). The CPU 101 generates a control signal based on the obtained measured information and writes the generated control information to the frame memory 102 through the memory bus 112 (region 205). In this case, control information is associated with the scaled picture data written in the frame memory 102 in the preceding region 203 and written to the frame memory 102.

After the control information is written to the frame memory 102, the frame rate converting process and high quality picture producing process are performed. In region 206, a frame to be read from the frame memory 102 is decided. Control information associated with the decided frame is read from the frame memory 102. The control information that has been read is supplied to the picture processing controlling block 110. Control information that has been set to the picture processing controlling block 110 is updated into the control information that has been read from the frame memory 102.

The picture processing controlling block 110 performs the high quality picture producing process in synchronization with output vertical synchronous signal Vsy2. Den2 represents an enable signal of output picture data. A high level region of Den2 is a picture region. A low level region of Den2 is a vertical blanking interval. A frame to be read is decided, control information is read, and control information of the picture processing controlling block 110 is updated into the control information that has been read (region 206) in a vertical blanking interval. Since control information is updated before picture signal is updated, the high quality picture producing process can be performed for the picture signal in the same vertical interval in region 207 based on the updated control information.

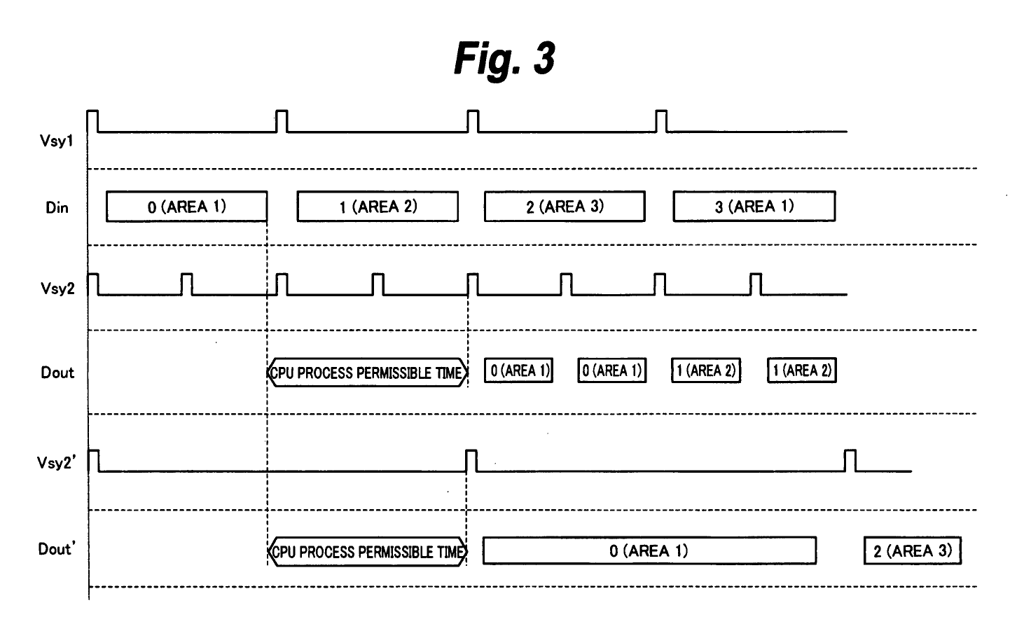

As shown in a timing chart of FIG. 3, the frame rate converting block 109 performs the frame rate conversion for picture data. The frame memory 102 has three memory areas (area 1, area 2, and area 3) for three frames. Input picture data Din in synchronization with input vertical synchronous signal Vsy1 are successively written to each area of the frame memory 102.

When the frame rate of the output picture data is around twice that of the input picture data, the frequency of output vertical synchronous signal Vsy2 is around twice that of Vsy1. While the input picture data are being written to the frame memory 102 one time, the frame rate converting block 109 reads the same frame twice. This process is literally referred to as repeating.

When the frame rate of the output picture data is around half of that of the input picture data, the frequency of output vertical synchronous signal Vsy2 is the half of that of Vsy1. To display the input picture data in real time without causing the frame memory area to overflow, it is necessary to skip over frames. This process is literally referred to as skipping.

When the frame rate conversion for the input picture data is performed, the input picture data may be interpolated corresponding to their motions. In the skipping process, as well as a method of repeating the same picture, moving pixels of an added frame may be substituted with pixels of which pictures of the preceding and following frames have been interpolated. When the frame rate conversion is performed, the frequency of the horizontal scanning lines is doubled (in the case of repeating) or the frequency is halved (in the case of skipping).

In such a manner, the frame rate conversion for the input picture data is performed. Normally, when the frame rate conversion is performed, the picture scaling block 108 that writes picture data is allowed to write picture data to a memory area from which the frame rate converting block 109 is reading picture data for which the frame rate conversion been performed only when the frame rate converting block 109 has completely read the picture data and is allowed to write the picture data to an area from which the frame rate converting block 109 is not reading the picture data to prevent the wiring side from overtaking, namely overwriting picture data that the reading side is reading (displaying). In the system that controls the frame rate conversion by the repeating and skipping processes, as shown in FIG. 3, a period larger than one cycle of input vertical synchronous signal Vsy1 can be used as a process time of the CPU 101.

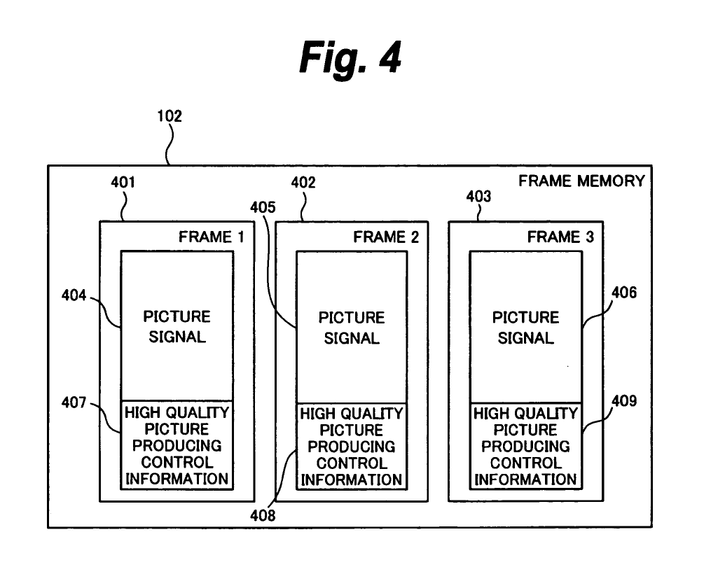

Next, with reference to FIG. 4, packing of data stored in the frame memory 102 will be described. The frame memory 102 can be allocated an area 401 for frame 1, an area 402 for frame 2, and an area 3 for frame 3. The picture scaling block 108 successively and cyclically stores scaled pictures to a picture data area 404, a picture data area 405, and a picture data area 406.

The CPU 101 calculates control information based on measured information measured by the picture measuring block 107 and successively and cyclically stores the calculated control information to a control information area 407, a control information area 408, and a control information area 409. In this case, picture data generated by the frame rate converting block 109 and control information calculated by the CPU 101 are packed and stored to each area.

The frame rate converting block 109 determines whether to perform the skipping process or the repeat process. The frame rate converting block 109 selects the frame area 401, 402, or 403 based on the determined result. First, the frame rate converting block 109 reads the control signal from the selected area in synchronization with the output vertical synchronous signal and updates setting of control information of the picture processing controlling block 110 into the control signal that has been read. Next, the frame rate converting block 109 reads picture data from the area 404, 405, or 406 and performs the frame rate conversion for the picture data. The picture processing controlling block 110 performs high quality picture producing control for the picture data that have been read.

The picture processing controlling block 110 has an updating section that updates its setting into control information for high picture quality (register group for high quality picture producing control) received from the upstream-side frame rate converting block 109. The picture processing controlling block 110 does not directly obtain high quality picture producing control information from the frame memory 102 because the frame rate converting block 109 decides an area of the frame memory 102 (area 404, 405, or 406 shown in FIG. 4) from which picture data are read by the foregoing skipping process and repeating process. In addition, the frame rate converting block 109 reads high quality picture producing control information (any area of area 407, 408, and 409 shown in FIG. 4) in a blanking interval before reading picture data from any of the areas 404, 405, and 406.

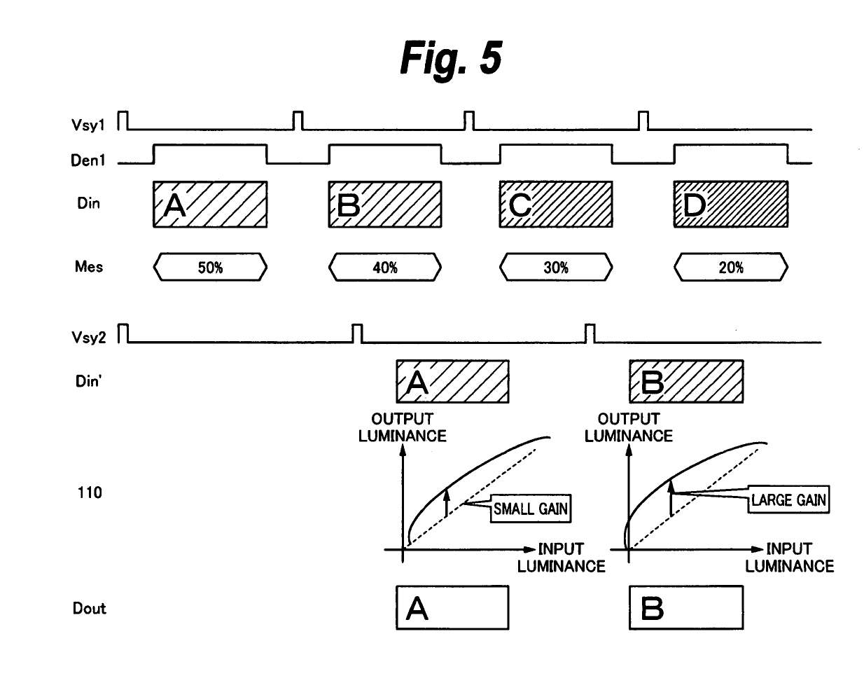

Next, with reference to FIG. 5, a more specific embodiment of the present invention will be described. In this embodiment, the picture measuring block 107 measures APL (average picture luminance). The picture processing controlling block 110 controls input/output luminance characteristics corresponding to APL. APL is 100% when all pixels of the screen are the maximum level (white) and 0% when all pixels of the screen are the minimum level (black). APL is represented as a percentage value.

The timing chart shown in FIG. 5 is more specific than that shown in FIG. 2. FIG. 5 shows input vertical synchronous signal Vsy1, data enable signal Den1, and input picture signal Din. In input picture signal Din, frames A, B, C, and D are arranged in the order of higher APLs. The picture measuring block 107 measures APL of each frame of the input picture signal and obtains the measured results of APLs (measured picture information) in each frame interval. For example, APLs of frames A, B, C, and D are 50%, 40%, 30%, and 20%, respectively.

The picture scaling block 108 writes picture data to the frame memory 102. The frame rate converting block 109 reads picture data from the frame memory 102. In the example shown in FIG. 5, the frame rate is halved by the skipping process.

Picture data Din′ that are input to the picture processing controlling block 110 synchronize with output vertical synchronous signal Vsy2. Picture data Din′ are data for which the scaling and frame rate conversion have been performed. However, APLs of picture data Din′ are the same as those of input picture data. APL of frame A is 50%, whereas APL of frame B is 40%.

The picture processing controlling block 110 uses input/output luminance control characteristics of which the gain at which the level of input luminance 50% is enlarged is the maximum. At this point, control expressed by the following formula is performed, assuming that the ratio of the level of the input data and the level of the output data is denoted by Gain.

Gain=input luminance×(100%−input luminance)

By substituting 50% into “input luminance” of the above formula, 25% can be obtained as a value of GainMax. With the value of GaimMax, enlarged Gain that depends on the measured APL is defined as follows.

Enlarged Gain=(100%−APL)×GainMax

From this formula, the higher APL is, the lower the enlarged Gain becomes. In other words, high quality picture producing control is not performed. In contrast, the lower APL is, the higher the enlarged Gain becomes. Thus, control for enlarging luminance characteristics of the entire screen is performed. As is clear from FIG. 5, since picture A that has high APL has low enlarged Gain, the level of the luminance enlarging process is low. In contrast, it is clear that picture B having lower APL than that of picture A is controlled with higher enlarged Gain than that of picture A.

It should be understood by those skilled in the art that various modifications, combinations, sub-combinations and alternations may occur depending on design requirements and other factors insofar as they are within the scope of the appended claims or the equivalents thereof. For example, the present invention may be applied to other controls such as contour correction instead of control of input/output luminance characteristics for high quality picture producing control.

What is claimed is:

1. A picture signal processing apparatus which performs a frame rate conversion for an input picture signal and obtains an output picture signal, the picture signal processing apparatus comprising:
storing means for storing picture data for two frames or more;
picture measuring means for measuring picture information of the input picture signal for which the frame rate conversion has not been performed using a frame delay period which occurs when the frame rate conversion is performed;
control information generating means for generating control information based on the picture data to perform a high quality picture producing process based on the picture information and storing the generated control information and the picture data associated therewith to the storing means;
frame rate converting means for performing the frame rate conversion for the picture data supplied from the storing means based on the control information supplied from the storing means; and
picture process controlling means for performing the high quality picture producing process for the picture data supplied from the frame rate converting means based on the control information supplied from the frame rate converting means,
wherein the picture process controlling means matches phases of the picture data and high quality picture producing control.

2. The picture signal processing apparatus as set forth in claim 1,
wherein the picture process controlling means obtains the control information without necessity of accessing the storing means.

3. The picture signal processing apparatus as set forth in claim 1,
wherein the control information generating means is a central processing unit (CPU).

4. A picture signal processing method of performing a frame rate conversion for an input picture signal and obtaining an output picture signal, the picture signal processing method comprising the steps of:
measuring picture information of the input picture signal for which the frame rate conversion has not been performed using a frame delay period which occurs when the frame rate conversion is performed;
generating control information based on the picture data to perform a high quality picture producing process based on the picture information and storing the generated control information and the picture data associated therewith to storing means;
performing the frame rate conversion for the picture data supplied from the storing means based on the control information supplied from the storing means; and
performing the high quality picture producing process for the picture data supplied after the frame rate converting step based on the control information supplied after the frame rate converting step,
wherein the picture process controlling step is performed by matching phases of the picture data and high quality picture producing control.

5. The picture signal processing method as set forth in claim 4,
wherein the picture process controlling is performed by obtaining the control information without necessity of accessing the storing means.

6. A picture signal processing apparatus which performs a frame rate conversion for an input picture signal and obtains an output picture signal, the picture signal processing apparatus comprising:
a storing section which stores picture data for two frames or more;
a picture measuring section which measures picture information of the input picture signal for which the frame rate conversion has not been performed using a frame delay period which occurs when the frame rate conversion is performed;
a control information generating section which generates control information based on the picture data to perform a high quality picture producing process based on the picture information and stores the generated control information and the picture data associated therewith to the storing section;
a frame rate converting section which performs the frame rate conversion for the picture data supplied from the storing section based on the control information supplied from the storing section; and
a picture process controlling section which performs the high quality picture producing process for the picture data supplied from the frame rate converting section based on the control information supplied from the frame rate converting section,
wherein the picture process controlling section matches phases of the picture data and high quality picture producing control.
